(19) United States
(12) Patent Application Publication
(10) Pub. No.: US 2014/0244532 A1
(43) Pub. Date: Aug. 28, 2014

(54) CANDIDATE AND JOB TRENDING IN EMPLOYMENT SYSTEM

(71) Applicant: Gozaik LLC, (US)

(72) Inventors: Joe Budzienski, Newton, MA (US); Ken Zimmerman, Boston, MA (US); Kelsey A. Curtis, Somerville, MA (US); Lauren Simonelli, Brighton, MA (US); Venkat Naidu Janapareddy, Woburn, MA (US)

(21) Appl. No.: 13/778,410

(22) Filed: Feb. 27, 2013

(51) Int. Cl. G06Q 10/10

(52) U.S. Cl. CPC G06Q 10/1053
USPC 705/321

(57) ABSTRACT

Systems and methods described herein provide an application through which social media can accelerate communication between a job seeker and a talent seeker (e.g., an employer).

### BACKGROUND

There are various manners in which job seekers and employers can connect. For example, an employer can post information about a job and receive a resume from the job seeker in response to the posting. A resume can be a document used to present an individual's background and skillsets. A resume often contains a summary of relevant job experience and education and can be provided to the potential employer as a hard copy (e.g., a paper copy) or in an electronic form (e.g., a document sent via e-mail).

### SUMMARY

In one aspect of the present disclosure, a method performed by one or more processing devices includes identifying, by a computer system, a plurality of trending job posts from job posts maintained in a social networking platform based at least in part on a number of individuals who have responded to the job post; associating a user-selectable control with the trending job posts; sending data to a user device to cause the user device to display at least some of the trending job posts and the associated selectable controls; receiving, at the computer system from the user device, an indication of interest in a particular one of the trending job posts based on selection of the selectable control associated with the particular one of the trending job posts by the user device; and generating, by the computer system, a post in the social networking platform of an employer associated with the particular trending job post for which the indication of interest was received, the post including response text and a link to a resume of a user associated with the user device.

Embodiments can include one or more of the following.

Identifying the plurality of trending job posts can include identifying the trending job posts based on a score calculated based on a first component indicative of user interest related to a job posting and a second component indicative of employer activity associated with the job posting.

Identifying the plurality of trending job posts can include for a plurality of job postings, calculating a trending score based at least in part on a number of times the job posting has been viewed and a number of users who have responded to the job posting and selecting from the job postings the trending job posts based on the calculated trending scores.

Identifying the plurality of trending job posts can include identifying trending posts based on a score calculated according to score=Σ(a*ARₚₒₛₜ+b*SRₚₒₛₜ+c*VRₚₒₛₜ+d*Aₑₘₚ+e*CFₑₘₚ) where a, b, c, d, and e are weighting factors, ARₚₒₛₜ is a measure of how many users have applied for the job posting, SRₚₒₛₜ is a measure of how many users have shared the job posting with other users, VRₚₒₛₜ is a measure of how many users have viewed the job posting, Aₑₘₚ is a measure of the employer's activity level in the job posting system, and CFₑₘₚ is a measure related to the company.

Identifying the plurality of trending job posts can include identifying trending posts based on a score calculated based at least in part on a measure of how many users have applied for the job posting, a measure of how many users have shared the job posting, a measure of how many users have viewed the job posting, and a measure of the employer's activity.

The method can also include sending data to a user device to cause the user device to display a visual indicia of viewing and application rate information for the trending job posts.

The method can also include prior to identifying the plurality of trending job posts, filtering a set of job posts to remove job posts having an activity level below a threshold.

The method can also include receiving from the employer at the computer system a request to view a resume of a user associated with the post in the social networking platform of the employer and enabling access to the employer to view the resume of the user.

In some aspects, a computer implemented method can include identifying, by a job posting system, a plurality of trending users from a plurality of users of the job posting system based at least in part on a number of employers who have viewed the user's resume; associating a selectable control with the trending users; sending data to an employer device to cause the employer device to display at least some of the trending users and the associated selectable controls; receiving, at the job posting system from the employer device, a request to view a resume of a trending user based on selection of the selectable control associated with a particular one of the trending users; and enabling access to the employer to view the resume of the trending user.

Embodiments can include one or more of the following.

Identifying the plurality of trending users can include identifying a trending users based on a score calculated based on a first component indicative of employer interest related to particular user and a second component indicative of user activity.

Identifying the plurality of trending users can include for a plurality of users, calculating a trending score based at least in part on a number of times the user's resume has been viewed and selecting the trending users based on the calculated trending scores.

Identifying the plurality of trending users can include identifying trending users based on a score calculated according to score=Σ(a*CRₑₘₚ+b*SRₑₘₚ+c*IRₑₘₚ+d*Lᵤₛₑᵣ+e*SRᵤₛₑᵣ+f*ACᵤₛₑᵣ) where a, b, c, d, e, and f are weighting factors, CRₑₘₚ is a measure of how frequently the user's resume is viewed by an employer, SRₑₘₚ is a measure of how frequently an employer shares a user's resume, IRₑₘₚ is a measure of how often employer initiates an interview with the user, Lᵤₛₑᵣ is a measure of how frequently the user logs into the job posting system, SRᵤₛₑᵣ is a measure of how frequently the user shares job postings with other users, and ACᵤₛₑᵣ is a measure of how many times the user has applied for a job using the job posting system.

Identifying the plurality of trending users can include identifying trending users based on a score calculated based at least in part on resume viewing information; interview request information; resume sharing information; and user activity information.

The method can also include sending data to the employer device to cause the employer device to display a visual indicator of factors influencing identification of the user as a trending user.

The method can also include prior to identifying the plurality of trending users,

filtering a set of users to remove users having an activity level below a threshold.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features will be apparent from the description and drawings, and from the claims.

### BRIEF DESCRIPTION OF THE DRAWINGS

FIG. 1 illustrates exemplary graphical user interfaces for displaying and responding to a job posting using a social network.

FIG. 2 is a flow chart of an exemplary process for connecting a job seeker with a potential employer.

FIG. 3 illustrates an example of a graphical user interface for providing text used to respond to a job posting.

FIG. 4 illustrates an example of a graphical user interface for displaying a filtered set of job postings.

FIG. 5 illustrates an example of a graphical user interface for displaying a social media feed of an employer.

FIG. 6 illustrates an example of a graphical user interface for displaying job postings.

FIG. 7 illustrates an example of a graphical user interface for displaying job postings.

FIG. 8 is a flow chart of an exemplary process for presenting job postings.

FIG. 9 is a flow chart of an exemplary process for generating automatic responses to job postings.

FIG. 10 illustrates an example of a graphical user interface for providing text used to respond to a job posting.

FIGS. 11A and 11B illustrate exemplary graphical user interfaces for displaying trending users.

FIG. 12 is a flow chart of an exemplary process for identifying trending users.

FIGS. 13A and 13B illustrate exemplary graphical user interfaces for displaying trending job postings.

FIG. 14 is a flow chart of an exemplary process for identifying trending job postings.

FIG. 15 is an example of a system.

### DETAILED DESCRIPTION

A system consistent with this disclosure provides an application through which social media can accelerate communication between a job seeker and a talent seeker (e.g., an employer). One manner in which employers seek applicants is by posting information about a job opening or position in a social network. Posting the job opening in the social network can allow the information about the position to be viewed by a large and diverse set of individuals who might not otherwise be informed about the opening. Often a job seeker's feed in the social network can become overwhelmed with updates and job postings (e.g., brief job announcements that are posted to the social network feed, further details about the job advertised in the job announcement/posting can be viewed on a third party job board or the company's website) especially if the user is following or connected to a large number of entities. As a consequence, job postings of interest to the job seeker may be missed. Additionally, viewing information about each of the potential job postings and completing the appropriate application process can be time consuming (e.g., an employer may direct an applicant to apply via their online website or to send a resume to a particular address). This multi-step application process may have a negative impact on both the job seeker and the employer. The job seeker may miss out on job postings that potentially may be of interest. The employers may not receive the resumes or other expression of interest in the job posting such as a tweet or e-mail from all potential respondents. To help encourage connections between the job seeker and the employer, such job-related postings may be extracted from the social networking platform, aggregated, filtered and presented to the user in a user-friendly interface. The systems and methods described herein also assist a job seeker to quickly respond to such job postings in the social network by automatically posting a response to the job posting in the social media of the employer for jobs which the job seeker has expressed interest. In each automatically generated message where the system composes the message and the user can customize or amend prior to the user sending the message, a link back to the job seeker's online portfolio (“resume”) is provided. Employers view the postings in their feed in the social media network and if interested, review the job seekers profile and resume.

There are many different examples of electronic social networking platforms. FACEBOOK, TWITTER, LINKEDIN, GOOGLE+, MYSPACE, and ORKUT are just a few examples. But, there are many others, and it is reasonable to expect many more to be launched in the future. The techniques described herein for handling data available from an electronic social networking platform are widely applicable and may be applied to data available from any relevant electronic social networking platform.

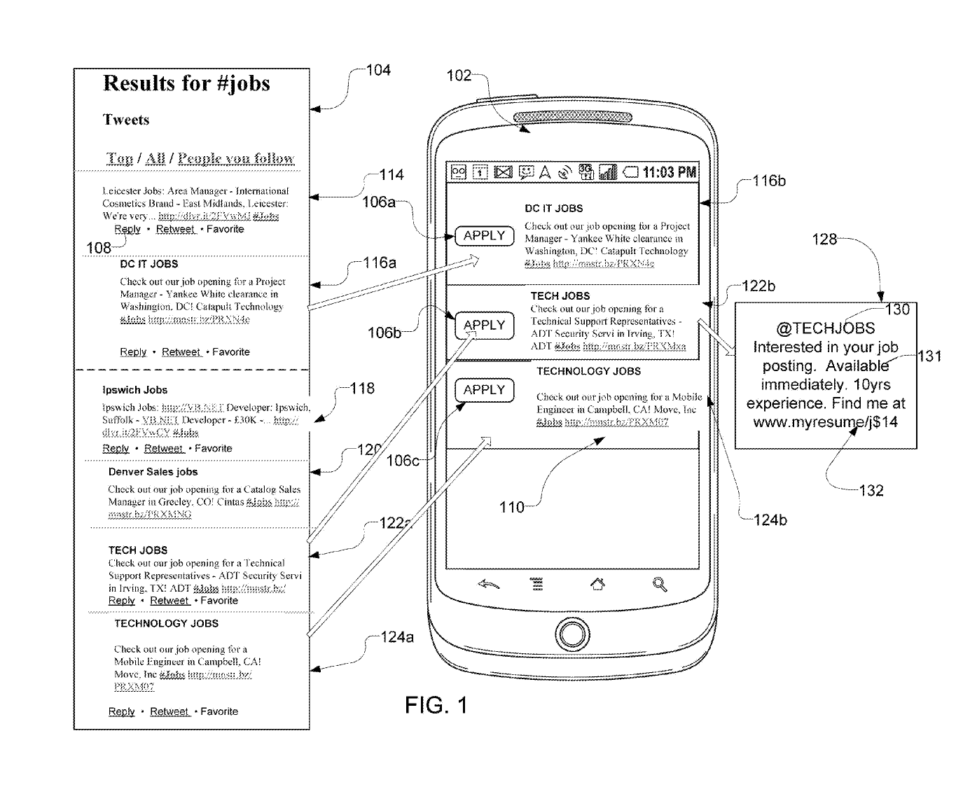

FIG. 1 illustrates aggregation, display, and responses to posts from an electronic social networking platform. The left hand side shows an exemplary post feed 104 for a social network. In this example, the posts 114, 116a, 118, 120, 122a, and 124a included in the feed are selected based on criteria related to the posts. For example, the feed can include posts based on inclusion of a particular symbol (such as a hashtag used by Twitter) before a keyword in the post. In this particular example, a “#jobs” hashtag is used to generate the listing of posts. Thus, the feed includes any messages/posts that include the identified keyword or phrase. The items presented in post feed 104 on the social networking page provide mechanisms that enable the particular user to interact with the items presented in the post feed. For example, each of the posts presented in post feed includes a selectable “Reply” control, for example, the reply control 108. The selectable “Reply” control in a post enables the user to enter a responsive comment to the object(s) included in the post. The electronic social networking platform posts such responsive comments to a social media feed of the poster. These responses can be public (e.g., viewable by other users) or private (e.g., viewable by only the originator of the post). Selection of the reply control 108 generates a blank entry form in which a user can input (e.g., by typing) a response to be posted to the social media feed of the originator.

As noted above, a feed in a social network can become overwhelmed with updates, especially if the user is following or connected to a large number of entities or if posts related to a particular topic are provided with regularity. For example, hundreds of jobs may be posted to a feed in a social network related to job openings every minute. These jobs may range from an opening for a chef at a local restaurant, to an opening for a landscaper, to an opening for a computer programmer. Thus, only a subset of job postings in a social network are likely to be relevant to a particular job seeker.

The systems and methods described herein filter the posts in the social media network to generate a filtered subset of posts that meet certain criteria (as shown in user interface 102). As described in more detail below, the posts from the social media network can be filtered based on interest (e.g., particular job categories), location, required skills, or keyword. Other types of filtering could additionally/alternatively be used. In some examples, the filtering is based on words in the job posting rather than on structured data such as the location. In the particular example of FIG. 1, a general job posting feed from the social network (shown as feed 104) is filtered based on job type to provide a filtered listing of jobs related to computer programming and information technology to generate a filtered feed 102 that includes posts 116b, 122b, 124b which correspond to posts 116a, 122a, 124a in feed 104.

Each of the posts in the filtered listing 102 includes a selectable control. For example, each of the posts presented in post feed includes a selectable “apply” control 106a, 106b, and 106c. The selectable “apply” control in a post enables the particular user to automatically provide a response to the post in the social media feed of the posting entity associated with the post based on an indication of their interest in the job posting, such as the user selecting the selectable control. The text of the response, it is automatically accessed by the job posting system and used as the text for a post to the employer social media feed in response to selection of the apply control (e.g., the user does not need to type or otherwise input the text for the reply at the time of responding to a particular job posting). Automatically generating the response text is believed to shorten the time required to respond to a job posting in the social media feed because the user is not required to generate/input the text at the time of submitting the response. Further, automatically inputting the previously stored response text can provide the benefit of decreasing the likelihood that typographical errors such as errors in the URL to a job seekers resume will occur. The posts generated in the employer's feed can be public (e.g., viewable by other users) or private (e.g., viewable by only the originator of the post). For example, selection of the apply control 106b associated with post 116b in feed 102 generates a post 128 in the social media network of the entity which provided the job posting. More particularly, in this example, an entity called “TECH JOBS” provided the initial job posting 122a, which was displayed in the feed 102 as post-122b. Upon user selection of the selectable control 106b a responsive post 128 is generated, directed to the social media feed of “TECH JOBS” (as indicated by the @TECHJOBS address 130). The post 128 includes the address 130, pre-defined text 131 and a link 132 to a resume for the responding job seeker. Thus, by selecting a single selectable control on the user interface, a post including information about the job seeker and a link to his or her resume is automatically provided to the social media feed of the employer. The employer can view further information about job seekers who have responded to the job posting by selecting the link to the resume for the job seeker.

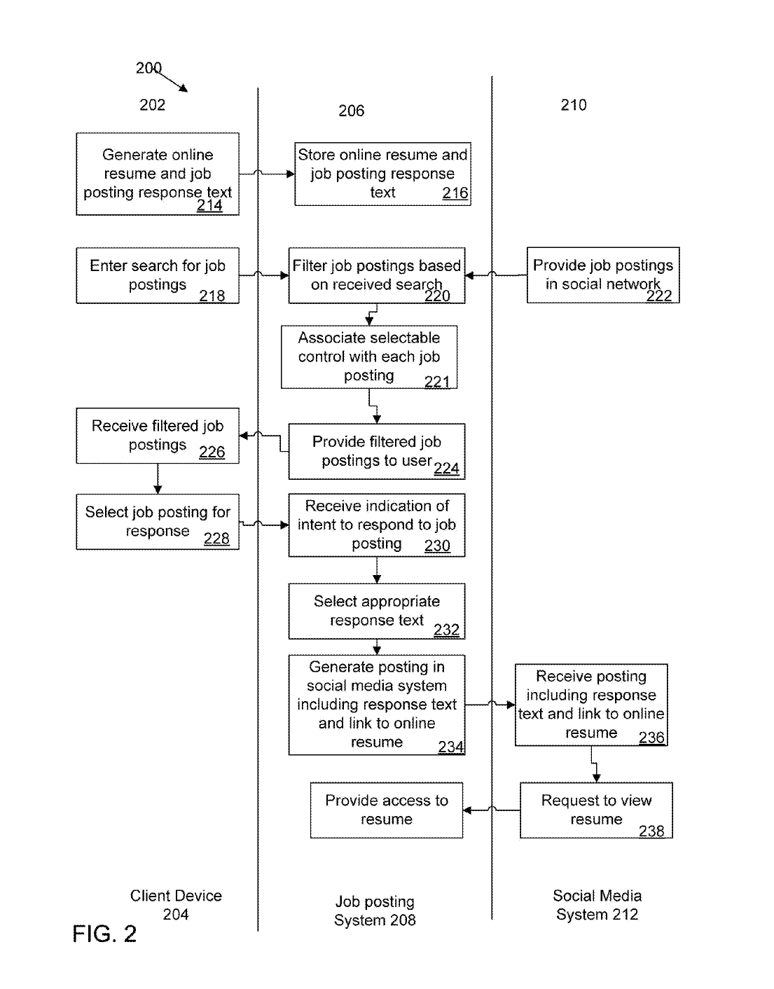

Referring now to FIG. 2, and exemplary process for connecting a job seeker with a potential employer is shown. In FIG. 2, process 200 is split into parts 202, 206, 210. Part 202 may be performed by a client device 204, such as a computer, mobile telephone, tablet computing device, or other computing device associated with a job seeker. Part 206 may be performed by job posting system 208. Part 210 may be performed by social media system 212.

In operation, a job seeker generates and maintains an online portfolio (“resume”) that contains the job seekers information, education, work history, skills, keywords, images, video and/or social media usernames (214). The job seekers online portfolio includes short text statements which succinctly announce the job seeker's personal marketing message. In some examples, the online portfolio includes a single short text statement which succinctly announces the job seeker's personal marketing message. The text statements can be character limited statements suitable for posting to a social media platform (e.g., character text statements of 140 characters or less, character text statements of 100 characters or less). These statements intended to be pushed (tweets via Twitter, Status via Facebook) to a social media platform in response to user initiation as described in more detail herein. The job posting system 208 stores the received online resume and job posting response text (216).

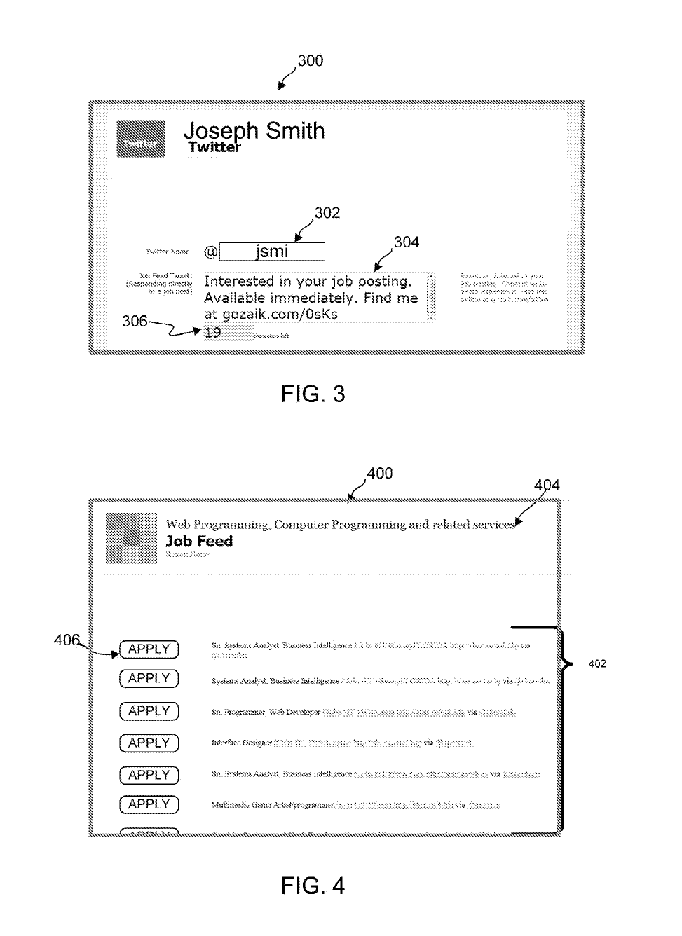

FIG. 3 shows an exemplary user interface 300 for providing a response text suitable for posting to a social media platform. In this example, a user named Joseph Smith provides their social media login name in user entry box 302. User interface 300 also includes a user entry box 304 in which the user can provide text that will form the response to a job posting. Because the social media outlet may limit the length of posts, a number of characters remaining is displayed on the user interface 300 as a characters left indicator 306. While the number of characters available may vary by social media platform, in general, it is believed that limiting the length of the post can be beneficial in aiding the employer to quickly can and review posts by potential job applicants.

Referring again to FIG. 2, after providing and storing an online resume and job posting response text, a job seeker associated with client device 204 enters a search for job postings (218). The job posting system 208 filters job postings from one or more social media platforms based on the received search (220). In order to generate a filtered listing of job related postings, the job posting system 208 receives from a social media system 212 a feed that includes job postings (222). For example, the job posting system 208 may aggregate multiple different social media feeds based on keywords likely to be associated with job postings. In a particular example, if the social media platform includes hash tags, or other indicators of content, the job posting system 208 may subscribe to feeds associated with relevant indicators (e.g., #Jobs, #IPjobs, #ITJobs). In some additional examples, the job posting system 208 can include a job posting entry user interface to enable employers to enter information about a job posting directly into the job posting system 208. Such entries can be combined with entries from the social media feed(s). The job posting system 208 associates selectable controls with each post in the filtered list of job postings (221), and provides the filtered list of job postings to the client device 204 (224). The client device 204 receives the filtered list of job postings (226).

The filtered list of job postings includes the text from the original post in the social media system and a selectable control by which the job seeker can respond to the post. FIG. 4 shows an exemplary user interface 400 that includes a filtered listing of job posts 402. The filtered listing of job posts includes posts related to a category, keyword, or search performed by the user as indicated by category information 404. Additionally, each post in the filtered listing of job posts 402 is associated with a selectable control 406. Selection of selectable control 406 by the user causes the response text associated with the user (e.g., entered in block 304 of user interface 300) to be posted in the social media feed of the employer who originally sent the job posting.

Referring again to FIG. 2, after receiving the filtered list of job postings (226), the user associated with client device 204 can select a job posting for response (228) by selecting the selectable control associated with the post. Upon selection by the user, the job posting system 208 receives an indication of the user's intent to respond to the job posting (230). Based on this received indication, job posting system selects the appropriate response text (232) and generates a posting in the social media system (either directly or indirectly) that includes the response text and a link to the online resume of the user associated with client device 204 (234). More particularly, in some examples, the job posting system sends a stub message to the social media system and the social media system produces a popup that allows the user to easily generate the posting. As such, when the job posting system generated the posting it may not directly generate the posting in the social media system but rather provide the user interface and application to enable the user to easily complete the posting (e.g., using the user's own authenticated session with the social media system).

Upon generation of the post by job posting system 208, the social media system 212 receives the posting that includes the response text and a link to the user's online resume (236). In order to connect with a particular user who has responded to the job posting, a reviewer at the social media system 212 can request to view one or more of the resumes by selection of the link in the social media feed (238) and the job posting system 208 can provide access to the stored resume (240).

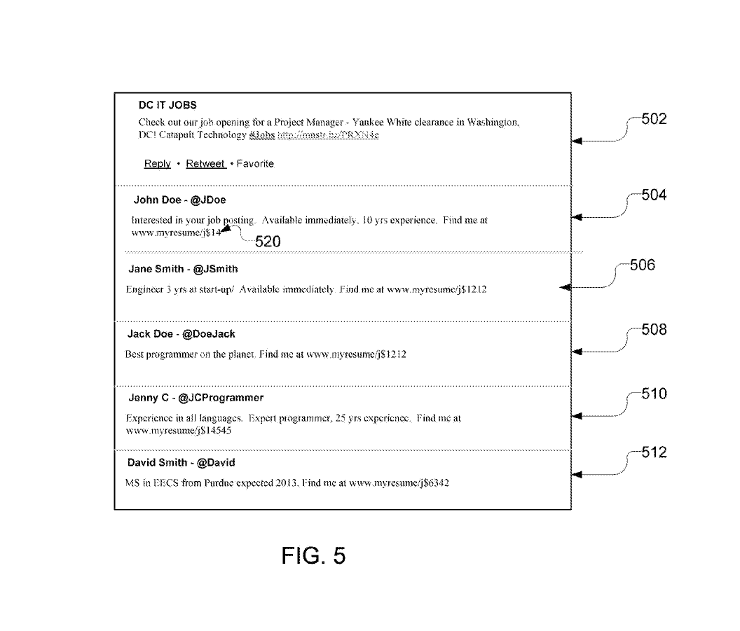

FIG. 5 shows an exemplary user interface 500 of the employer's social media feed. The employer social media feed includes an entry/post 502 that includes the job posting. It is this post that is originally received by the job posting system, provided to the client device 204, and for which responses in the form of posts to the employer's social media feed can be received. The following posts in the employer social media feed include responses (e.g., posts 504, 506, 508, 510, 512) received based on the original job posting 502. These posts include the username of the user associated with the client device 204 responsible for the post, the response text, and a link (e.g., link 520) to the resume for the user associated with client device 204. Thus, an employer can quickly scan a set of potential applicants based on their response text and view resumes of interest by selection of the link to the job seekers resume.

In some embodiments, in addition to providing a filtered listing of job postings based on post in a social media platform, the system can provide one or more sponsored job postings. For example, the job posting system can enable an employer to have one or more of their job postings displayed prior to the reverse chronological listing of job postings based on receipt of a payment from the employer to the job posting system.

FIG. 6 shows an exemplary user interface 600 for displaying job postings from one or more social networking platforms. User interface 600 is divided into two sections, a sponsored jobs section 602 and a reverse chronologically ordered job postings section 604. The sponsored job section 602 includes one or more job postings from the social networking platform that are promoted to the top of the job feed based on a received payment from the employer. For example, in a job feed displayed to a job seeker, a predetermined number of sponsored job postings can be displayed prior to the listing of job postings such as the listing shown in FIG. 4. The sponsored jobs included in the sponsored jobs section 602 can be selected based on a match between keywords in the search submitted by the job seeker and/or selected based on a category or field of jobs being viewed by the job seeker. In one particular example, the job posting system can provide multiple job type categories and the employer can select which of these categories to promote their job posting as a sponsored job. For the category selected by the employer, the job posting will be displayed in the sponsored jobs section 602 for job seekers searching/viewing job postings associated with the job type, category.

In some embodiments, in addition to providing a filtered listing of job postings based on posts in a social media platform, the system can provide one or more trending job postings. For example, the job posting system can track the number of individuals responding to various job postings, and generate a set of job postings that are popular. It is believed that providing a set of trending job postings can be beneficial to a job seeker as it can quickly identify to the job seeker a subset of jobs for which there is general excitement or interest amongst other job seekers.

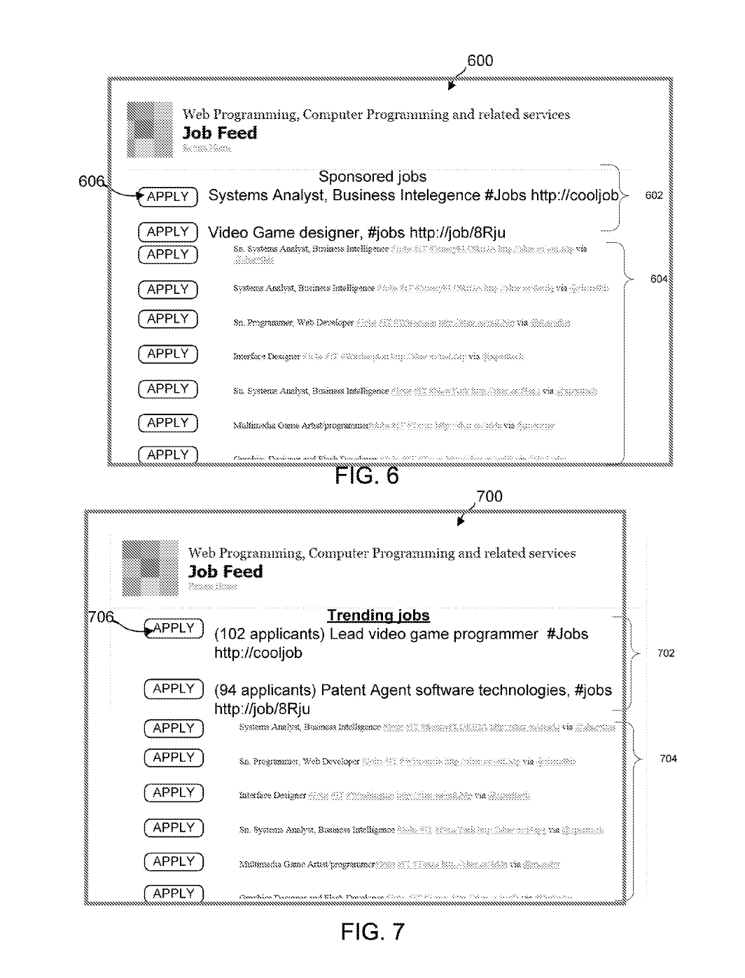

FIG. 7 shows an exemplary user interface 700 for displaying job postings from one or more social networking platforms. User interface 700 is divided into two sections, a trending job section 702 and a chronologically ordered job postings section 704. The trending job sections includes one or more job postings from the social networking platform that are promoted to the top of the displayed job feed based on a number of individuals who have responded to the job posting. For example, in a job feed displayed to a job seeker, a predetermined number of trending job postings can be displayed prior to the listing of job postings such as the listing shown in FIG. 4. The trending jobs included in the trending jobs section 702 can be selected based on a match between keywords in the search submitted by the job seeker and/or selected based on a response level calculated for the job posting. In one particular example, the job posting system can select the job postings to display in the trending jobs section 702 based on a time weighted average. For example, a score can be calculated based on the number of times the job posting has been displayed to job seekers, the number of job seekers who have responded to the job posting, a number of people following or favoriting the post and/or a time since the job posting was first presented. In one particular example, the score can be calculated based on the percentage of individuals viewing the job posting who have responded to the job posting. In another particular example, the score can be calculated based on a number of individuals who have responded to the job posting divided by a length of time that the job posting has been active in the system (e.g., a number of hours). The job postings included in the trending jobs section 702 can then be selected based on the calculated score. For example, by selecting a predetermined number of job postings having the highest scores.

In another example (not shown in the figures), a set of less popular job postings can be provided to a user. For example, a user with a less than stellar resume or job experience may have difficulty competing for a job posting for which many other job seekers have responded. Such an individual may desire to respond to job postings for which there is less competition. In order to identify job postings with a low number of respondents, the job posting system can sort job postings based on a score calculated from the number of job seekers who have responded to the job posting. For example, the job postings displayed in the job seekers job feed, can be sorted and displayed in an order that is based on the popularity of the job posting with job postings having a lower number of respondents displayed prior to job postings having a higher number of respondents. It is believed that displaying job postings with a low number of respondents can be beneficial to both the job seeker and the employer as it can identify to the job seeker job openings for which there is less competition and it can be beneficial to the employer because it can encourage jobseekers to apply for the job opening. In some examples, as discussed above, the job posting system does not directly generate the posting in the social media system but rather generates a message that the user can post within the social media system. In such situations, the number of respondents can be based on the number of individuals for which the system has generate the message which may differ slightly from the number of individuals who have actually sent the posting to the social media system.

In some additional examples, it can be beneficial to display the job postings included in an individual's job feed and in order that is based on a perceived relevance to the job seeker rather than presenting the job postings and a reverse chronological order. For example, a score can be calculated based on similarity between a jobseeker's user profile and a job posting. This score can be used to sort the job postings and display the job postings and in order that is based on the similarity between the jobseeker's user profile and the job posting.

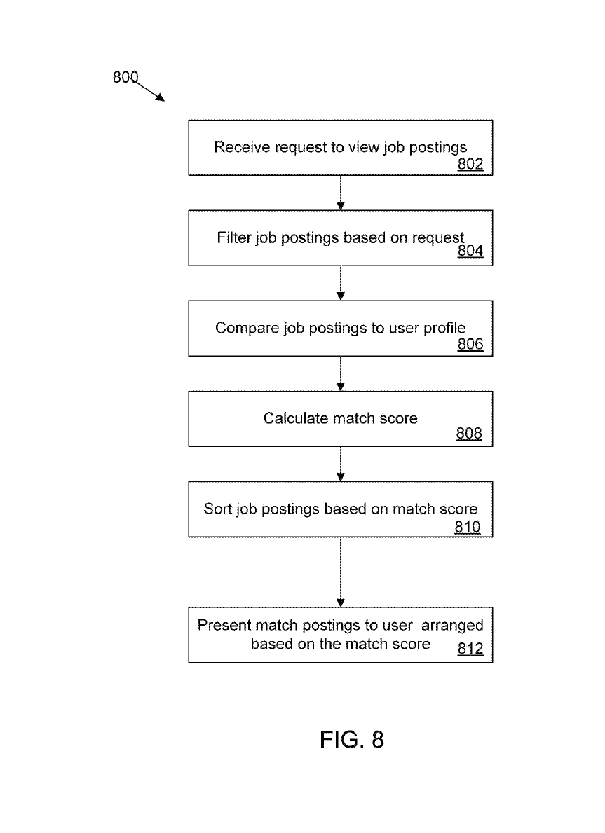

FIG. 8 shows a flowchart of a process 800 for displaying job postings and in order that is determined based at least in part on a calculated match score. The job posting system receives a request to view job postings from a job seeker (802). The job posting system filters job postings from one or more social media platforms based on the received request (804). Filtering the job postings from the one or more social media platforms generates a subset of job postings that are believed to be potentially relevant to the job seeker. Additionally, the job postings can be filtered based on a timestamp of the posting to remove postings that have been active in the system for a period of time exceeding a threshold. For the job postings in this identified subset, the job posting system compares the job posting to a user profile for the job seeker (806). Based on the comparison, the job posting system calculates a match score (808). The match score is indicative of similarity between the job posting and the user profile of the job seeker. After calculating match scores for the subset of identified job postings, the job posting system sorts the job postings in the identified subset based on the calculated match scores (810). The job posting system presents the client device the job seeker a filtered set of job postings that are arranged in an order that is based at least in part on the calculated match score. In one particular example, the order can be based on the match score such that job postings are displayed in order of descending match scores. In another example, the order can be based on both the match score and a length of time the job posting has been active in the system.

In some embodiments, in addition to enabling the job seeker to easily respond to job postings, the job posting system can additionally provide automatic responses to job postings for the job seeker. For example, the job posting system can select a subset of job postings which appear to be relevant for the job seeker and automatically respond to the job posting for the job seeker. It is believed that, in some situations, automatically responding to job postings for a job seeker can be beneficial to both the job seeker and the employer. For example, automatically responding to job postings having a high degree of relevance to the job seeker can assist the job seeker in having their resume viewed by potential employers. Additionally, automatically responding to job postings can be beneficial to the employer because the employer may view additional resumes of individuals who otherwise may not have responded to the job posting. Responses that have been automatically generated by the job posting system can include indicia indicative of the automatic nature of the response in the post added to the employer's social media feed. Thus, when reviewing responses in the social media feed, the employer can determine which responses were actively submitted by the job seeker and which were provided automatically.

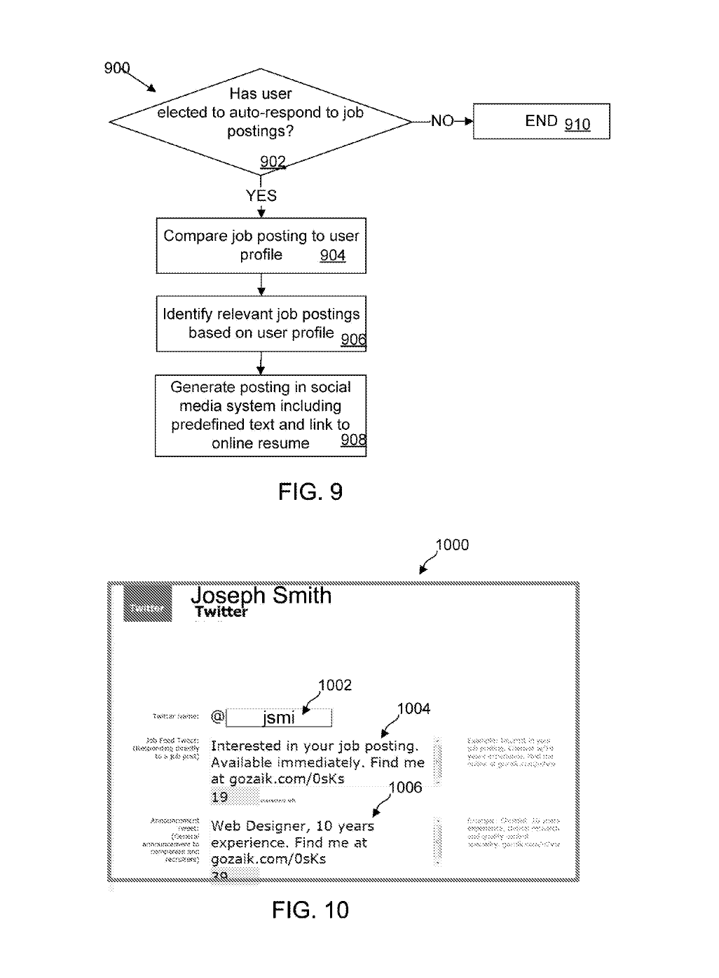

FIG. 9 shows a flowchart of a process 900 for automatically generating posts in a social media platform of an employer. The job posting system determines whether a particular user has elected to auto respond to job postings (902). If the user has not elected to auto respond to job postings, the automated response process ends (910). On the other hand, if the user has elected to auto respond to job postings, the job posting system compares received job postings to the user's profile (904). Based on the comparison of the job posting to the user profile, the job posting system identifies relevant job postings (906). For example, the system can compare the calculated score to a threshold to select job postings having match scores exceeding the threshold. In another example, the job posting system can sort job postings to identify a predetermined number of job postings for which an automatic response should be generated by identifying the job postings having the highest scores. After identifying relevant job postings, the job posting system generates a post in the social media platform of the employer for job postings identified based on the comparison of the job posting to the users profile (908). The posting in the social media feed of the employer includes predefined text provided by the job seeker and a link to the job seeker's online resume. In some examples, the post in the social media feed of the employer can additionally include an indicia indicative of the automatic nature of the response.

FIG. 10 shows an exemplary user interface 1000 for providing a response text suitable for posting to the social media platform. In this example, a user named Joseph Smith provides their social media login name in user entry box 1002. User interface 1000 also includes a user entry box 1004 in which the user can provide text that will form the response to a job posting for which the job seeker has actively responded to the job posting (e.g., by clicking the apply button as shown in FIG. 1 above). User interface 1000 also includes a user entry box 1006 which the user can provide text that will form the response to a job posting for which the job posting system has automatically responded to the job posting on behalf of the job seeker. Separate entries and texts are provided such that the job seeker can have different text provided based on whether they have actively or automatically responded to the job posting.

Trending Candidates

In some examples, the job posting system can spotlight “trending” candidates. Resumes/users with the most activity can trend within an employer's dashboard, creating both candidate demand as well as competition. For example, the job posting system can utilize information about a user's activity as well as employer activity to generate a set of candidates that are popular (e.g., a set of candidates whose resumes are viewed more often than others, a user profile with a high activity level, a user resume that is being shared more frequently). It is believed that providing a set of trending job candidates can be beneficial to an employer as it can easily identify to the employer a subset of candidates for which there is general excitement or interest amongst other employers.

Various metrics can be used to identify trending job candidates. In general, the metrics can be based on a component that indicates employer interest and activity in a particular candidate and a component that indicates user activity within the job posting system. For example, scores can be calculated for users based on such factors and the users having the highest scores can be identified as trending users. In one particular example, the scores can be calculated according to a function such as: user score=f(activityᵤₛₑᵣ+interest_{employer}). It is believed that it can be beneficial to base trending users on both employer interest and user activity in order to increase the likelihood that a user identified as a trending user is still actively seeking a position and has received general interest among various employers. For example, if the scores used to select the scores used to identify the trending users were based solely on employer interest, a user who has ceased using the system because they have found a job or are no longer looking to change jobs could potentially still be included as a trending user even though they are not interested or seeking a new job position. Similarly, if the trending users were based solely on user activity, a user could potentially generate false information by taking numerous actions in the system which are unrelated to an employer's interest in the user.

The employer interest in various users can be based on various metrics such as which user profiles are clicked the most, which user profiles have the most activity, and which user profiles are being shared by employers. As discussed in more detail herein, when an employer views user posts submitted in response to a job posting, the employer has the option connect with the user, share the user post with others, and/or favorite the user. When the employer decides to connect with the user, the user is connected to the employer for purposes of further discussions about the job posting such as setting up an interview. When the employer shares the user, another posting or an e-mail is generated from the employer with the information about the user. When the employer favorites the user, the job posting system stores the user's post and/or other information about the user in a list of users for the employer so that the employer can later review the subset of candidates which they selected. Information collected by the job posting system about how frequently various users' resumes are viewed, connected to, shared, and favorited can be used to identify trending users.

The user activity component can be based on various metrics such as how frequently the candidate has accessed the job posting system during a recent period of time (e.g., has the candidate logged into the system at least once in the past week), how many job postings the candidate has responded to, and/or how many job postings, the candidate has shared with other users of the job posting system. Thus, the user activity component of the score used identify trending users can provide an indication of whether the user is actively using the job posting system to search for employment.

In one particular example, the user score, which is used to identify trending users is calculated based on a weighted summation of multiple factors. For example, the score can be calculated according to score=Σ(a*CRₑₘₚ+b*SRₑₘₚ+c*IRₑₘₚ+d*Lᵤₛₑᵣ+e*SRᵤₛₑᵣ+f*ACᵤₛₑᵣ) where a, b, c, d, e, and f are weighting factors, CRₑₘₚ is a measure of how frequently the user's resume is viewed by an employer, SRₑₘₚ is a measure of how frequently an employer shares the user's resume, IRₑₘₚ is a measure of how often employer attempts to initiate an interview with the user by connecting with the user, Lᵤₛₑᵣ is a measure of how frequently the user logs into the job posting system, SRᵤₛₑᵣ is a measure of how frequently the user shares all postings with other users, and ACᵤₛₑᵣ is a measure of how many times the user has applied for a job using the job posting system.

CRₑₘₚ can be calculated or determined using information available from the job posting system. In one example, to calculate CRₑₘₚ, the job posting system can track each time an employer or user clicks on a user's resume. In another example, to calculate CRₑₘₚ, the job posting system can track each time an employer clicks on a user's resume. In order to prohibit the user from clicking on their own resume, the job posting system can track only clicks on a user's resume from an employer and not clicks that originate from the user himself or from another user. Additionally, as an employer/user reviews resume, the employer/user may click on a user's resume multiple times in order to compare the user's resume with the resume of another user. As such, when calculating CRₑₘₚ the system can restrict the click count to a single registered click per ip address per a predetermined time (e.g., per day or per week). The data about clicks can be weighted to give a higher value to recent clicks and/or the data about clicks can be limited to a predetermined, recent time period.

SRₑₘₚ can be calculated or determined using information available from the job posting system. For example, to calculate SRₑₘₚ, the job posting system can track each time an employer shares a user's resume and SRₑₘₚ can be the number of shares the user's resume received during a particular time period. For example, an employer can share a resume with another individual within the company or with a contact at another company. Sharing of resume can indicate that the employer thinks the user may be of interest to another individual. In another example, the sharing data used to calculate SRₑₘₚ is not restricted to a particular time period, but rather the data is weighted to give a higher value to recent sharing activity than to older sharing activity.

IRₑₘₚ can be calculated or determined using information available from the job posting system. For example, to calculate IRₑₘₚ, the job posting system can track how frequently employers ask to connect with a user and IRₑₘₚ can be the number of connection requests the user's resume received during a particular time period. In another example, the connection data used to calculate SRₑₘₚ is not restricted to a particular time period, but rather the data is weighted to give a higher value to recent connection requests than to older connection requests.

Lᵤₛₑᵣ can be calculated or determined using information available from the job posting system. For example, to calculate Lᵤₛₑᵣ, the job posting system can track how frequently the user accesses the job posting system. For example, a value can be incremented each day that the user logs into the job posting system during a particular time period. Tracking of user login information can help to limit the number of users who are identified as trending users, who are no longer seeking employment because, once a user secures a job they are less likely to continue to log in to the job posting system.

SRᵤₛₑᵣ can be calculated or determined using information available from the job posting system. For example, to calculate SRᵤₛₑᵣ, the job posting system can track when a user shares a job posting another user and SRᵤₛₑᵣ can be the number of times a user shares a job posting during a particular time period. In another example, the sharing data used to calculate SRᵤₛₑᵣ is not restricted to a particular time period, but rather the data is weighted to give a higher value to recent sharing activity than to older sharing activity.

ACᵤₛₑᵣ can be calculated or determined using information available from the job posting system. For example, to calculate ACᵤₛₑᵣ, the job posting system can track how many job postings the user has applied for during a particular time period. In another example, the data used to calculate ACᵤₛₑᵣ is not restricted to a particular time period, but rather the data is weighted to give a higher value to recent job application activity than to older job application activity. Additionally, in some examples the job application activity can be capped or the value can be discounted if the application count is unusually high. Capping or discounting of the ACᵤₛₑᵣ value can limit the user's ability to increase the likelihood that they will become a trending candidate by applying to numerous, non-relevant job positions.

In some examples, the trending score for a user can be scaled based on the city or job market in which the user is applying. For example, a user in Boston, Mass. seeking a marketing position is likely to higher scores for resume views, clicks, sharing, applications, etc., as compared to a user in Boonville, Ind. seeking a marketing position due to the relative size of the job market in the two cities. Thus, a scaling factor can be used in order to ensure that users outside of large cities are still able to become trending candidates.

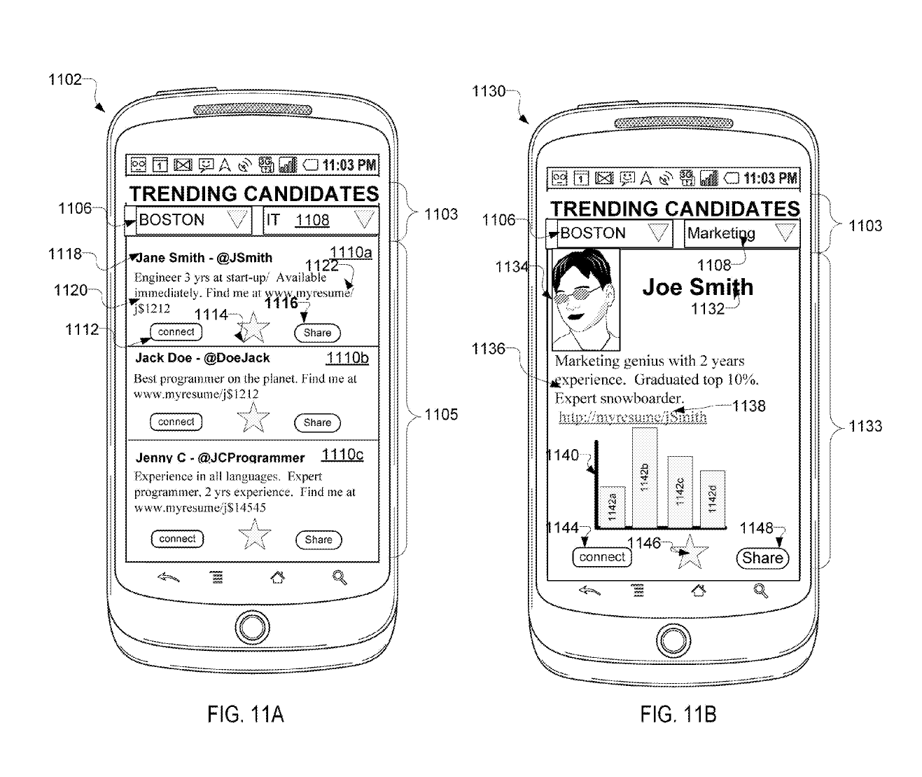

FIG. 11A shows an exemplary user interface 1102 for displaying trending candidates. The user interface provides an employer with a single location to view candidates for which there is general excitement or interest amongst other employers. User interface 1102 is divided into two sections, a filter section 1103 and a trending candidate section 1105.

The trending candidate section 1105 includes one or more posts 1110a-c that include the username 1118 of the trending user, the response text 1120, and a link (e.g., link 1122) to the resume for the user. Thus, an employer can quickly scan a set of potential applicants based on their response text and view resumes of interest by selection of the link to the job seekers resume. Each of the posts 110a-c in the trending candidate section 1105 includes selectable controls which enable the employer to connect with a user (e.g., connect button 1112), favorite the user (e.g., favorite button 1114), or share the user with others via a post or e-mail (e.g., share button 1116). Selection of the connect button 1112 generates a post to the user indicating the employer's interest in speaking with the user. For example, selection of the connect button 1112 can be the first step in forming a connection that is likely to lead to an interview for the user. Selection of the favorite button 1114 causes information about the user to be stored in a folder associated with the employer so that the employer can later review the subset of candidates which they selected. Use of the favorite button allows the employer to quickly identify a subset of users which look interesting for an open position and then later view those individuals as a group. Selection of the share button 1116 causes an e-mail or posting to a social network to be generated from the employer. If an e-mail is generated, the employer can select the recipients and the e-mail will include the original text of the post. If selection of the share button is enabled to generate a posting, a text statements suitable for posting to a social media platform (e.g., tweets via Twitter, Status via Facebook) can be generated which include the text of the original post or a link to the text of the original post.

The filter section 1103 of user interface 1102 provides the employer with a mechanism to filter trending candidates by job type (e.g., IT, marketing, legal, construction, etc.) and by location. To filter by location an employer can select a particular location using drop down menu 1106 and to filter by job type the employer can select a particular job type using drop down menu 1108. While filtering can enable an employer to view a subset of trending users in the location and/or job function for a particular need or job opening, in some examples an employer may desire to view an unfiltered list of trending users in order to see who the most popular currently available. Users are and then determine if there is a role for them in the company. In some examples, due to the number of job candidates in a particular market, the filtering may be limited to markets having a threshold volume of candidates in order to limit the number of searches which will result in few or no matching candidates.

In user interface 1102, multiple candidates are displayed on a single screen of a user device such as a mobile computing device, cellular telephone, etc. However, similar displays of trending candidates can be provided on a computer screen of a desktop or laptop computer. Additional trending candidates can be viewed by scrolling through a list of trending candidates.

FIG. 11B shows an exemplary user interface 1130 for displaying trending candidates. The user interface provides an employer with easy viewing of candidates for which there is general excitement or interest amongst other employers. In contrast to user interface 1102, user interface 1130 displays a single trending candidate at a time. The employer can click a button or swipe their finger across the screen to view a subsequent trending candidate. Similar to user interface 1102, user interface 1130 is divided into two sections, a filter section 1103 and a candidate section 1133.

The trending candidate section 1133 includes information about a trending candidate including the trending user's name 1132, a picture of the trending user 1134, a short text statement about the trending user 1136, and a link to the resume for the trending user 1138. Thus, an employer can quickly scan a set of potential applicants based on their response text and view resumes of interest by selection of the link to the job seekers resume. User interface 1133 also includes selectable controls similar to those described above in relation to user interface 1102 which enable the employer to connect with a user (e.g., connect button 1144), favorite the user (e.g., favorite button 1146), or share the user with others via a post or e-mail (e.g., share button 1148).

User interface 1133 also includes graphical indicia 1140 that provides information about which factors most strongly influenced trending of the candidate. In the example shown in user interface 1130, indicia 1140 is provided as a bar graph with four entries representing the number of looks or views of a user's resume 1142a, the number of interviews or connections the user has received 1142b, the number of jobs for which the user has applied 1142c, and in the user's activity level 1142d. The information provided and graphical indicia 1140 can help an employer to determine quickly whether the candidate may be of interest. For example, if the candidate has a very high number of views, but a very low number of interview requests, this differential can indicate to an employer that the users full resume may be less attractive than the snippet of information provided about the user. Additionally, if the user's activity level is very low, it can indicate to an employer that the user may be less interested or less actively seeking a job. While indicia 1140 is described in relation to user interface 1130 as being a bar graph, other representations of this information, or of the factors described above (e.g., CRₑₘₚ, SRₑₘₚ, IRₑₘₚ, Lᵤₛₑᵣ, SRᵤₛₑᵣ ACᵤₛₑᵣ) can be provided. For example, a pie chart showing the relative weightings of different factors could be included.

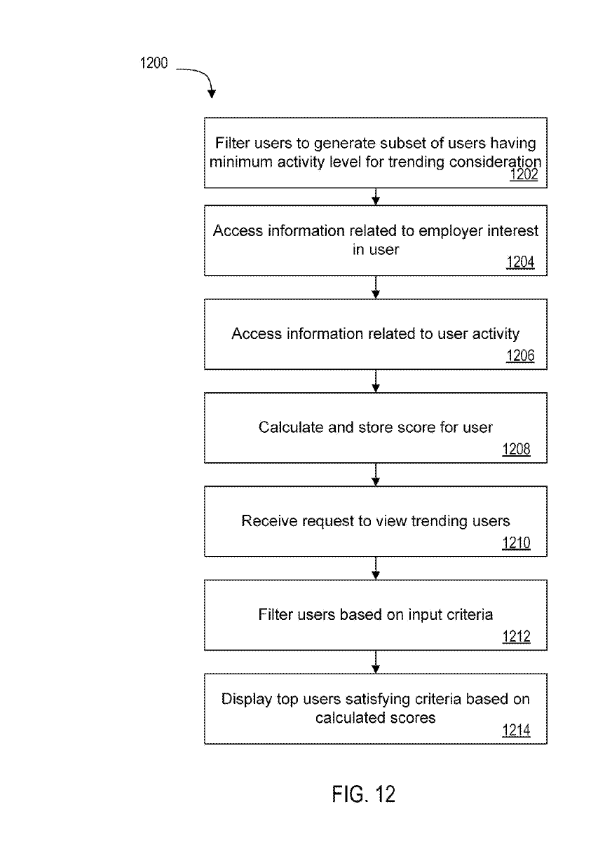

FIG. 12 shows a flowchart of a process 1200 for identifying and displaying trending users in the job posting system.

The job posting system filters users to generate a subset of users having a minimum activity level for trending consideration (1202). Filtering the users, based on activity level can ensure that a user who is no longer active within the job posting system does not become a trending user. For example, the job posting system can generate the subset of users by selecting only users who have logged into the system at least once in the past week (or another predetermined time period).

In order to calculate the scores for each of the users in the determined subset of users having the minimum activity level, the system accesses information related to employer interest in the user and information related to user activity in the job posting system (1204, 1206). Exemplary information the job posting system can access can include information about the number of times a user's resume has been viewed by different employers, the number of times employers have shared a user's resume, the number of times an employer is requested to connect with a user, the number of times a candidate has shared a job posting with another user, the number of times the candidate has logged in to the system during a particular time period, and/or the number of job postings to which the user has applied.

Using the accessed information, the job posting system calculates and stores scores for each of the users in the identified subset (1208). Such scores can be calculated, for example, as described above. The filtering of users (1202), accessing of information (1204, 1206), and calculating of scores for users (1210), can be performed on a regularly scheduled basis. For example, the job posting system can calculate new scores for users on a daily or hourly basis.

The job posting system receives a request to view trending users (1210). This request can include criteria by which the employer desires to filter candidates. For example, the job posting system can enable an employer to filter candidates based on industry type and location. The system filters users based on the employer input criteria (1212). Using the filtered subset of users, the job posting system displays trending users satisfying the criteria based on the calculated scores (1214). For example, the candidates satisfying the filter criteria can be displayed in order that is based on the calculated scores. Alternatively, only a small subset (e.g., 10, 20, 30) of users having the highest calculated scores can be displayed to the employer as trending users.

Trending Job Postings

In some examples, the job posting system can spotlight “trending” job postings. Job postings with the most activity can trend within the job posting system, thereby encouraging competition and excitement about the job posting. For example, the job posting system can utilize information about a user's activity as well as employer activity to generate a set of job postings that are popular (e.g., a set of job postings that are being frequently viewed, shared or applied for by users of the job posting system). It is believed that providing a set of trending job postings can be beneficial to an employer as it can increase interest in the job postings and can be beneficial to job seekers by allowing the job seeker to quickly identify job postings for which there is general excitement or interest amongst other users.

Various metrics can be used to identify trending job postings. In general, the metrics can be based on a first component that indicates user interest and activity related to a particular job posting and a second component that indicates employer activity within the job posting system. For example, scores can be calculated for job postings based on such factors and the job posting having the highest scores can be identified as the trending job postings. In one particular example, such scores can be calculated according to a function such as: posting score=f(activity_{employer}+interestᵤₛₑᵣ). It is believed that it can be beneficial to base trending job postings on both user interest and employer activity in order to increase the likelihood that an employer whose job posting is identified as a trending job posting is still actively seeking to fill the position and that the position in the job posting has received general interest amongst various users. For example, if the trending job postings were based solely on user interest, a job posting for which the position has been filled and is no longer available could potentially still be included as a trending job posting even though the employer is no longer seeking to fill the position.

The user interest in various job postings can be based on various metrics such as which job postings are clicked/viewed the most, which job postings have received the most activity, which job postings are being shared by users, and which job postings are most frequently applied to by users of the job posting system. As discussed in more detail herein, when a user views a job posting, the user has the option of applying to the job posting, sharing the job posting with others, and/or favoriting the job posting. When the user decides to apply for the job posting, the users resume is sent to the employer associated with the job posting. When the user shares the job posting, a posting or an e-mail is generated from the user with the information about the job posting. When the user favorites the job posting, the job posting is stored in a list of favorite job postings for the user to later review. Information collected by the job posting system about how frequently various job postings are viewed, applied to, shared, and favorited can be used to identify trending job postings.

The employer activity component can be based on various metrics such as how frequently the employer has accessed the job posting system during a recent period of time (e.g., has the employer logged into the system at least once in the past week), how many user resumes received in response to the job posting that the employer has viewed, and how many users the employer has connected to through the job posting. Additionally, in some examples, the employer activity score can additionally include a company status component. For example, the company status component can provide information about the size, benefits, vacation, popularity, and culture of the employer. The company status component can be based on data about the employer and/or based on user provided reviews of the employer.

For example, users can be asked to rank or rate various employers in this ranking or rating can be factored into the scores used to determine whether a job posting should be identified as a trending job posting.

In one particular example, a job posting score is used to identify trending job postings is calculated based on a weighted summation of multiple factors. For example, the score can be calculated according to score=Σ(a*ARₚₒₛₜ+b*SRₚₒₛₜ+c*VRₚₒₛₜ+d*Aₑₘₚ+e*CFₑₘₚ) where a, b, c, d, and e are weighting factors, ARₚₒₛₜ is a measure of how many users have applied for the job posting, SRₚₒₛₜ is a measure of how many users have shared the job posting with other users, VRₚₒₛₜ is a measure of how many users have viewed the job posting, Aₑₘₚ is a measure of the employer's activity level in the job posting system, CFₑₘₚ is a measure of the company status, desirability, or culture.

ARₚₒₛₜ can be calculated or determined using information available from the job posting system. ARₚₒₛₜ can be a count of the number of users who have applied for the job in the job posting during a particular time period. In another example, the user application data used to calculate ARₚₒₛₜ is not restricted to a particular time period, but rather the data is weighted to give a higher value to recent application activity than to older activity.

SRₚₒₛₜ can be calculated or determined using information available from the job posting system. For example, to calculate SRₚₒₛₜ, the job posting system can track each time user shares the job posting with another user and SRₚₒₛₜ can be the number of shares. The posting received during a particular time period. Sharing data can be useful in identifying trending postings because sharing of a job posting with another individual can indicate that the user thinks the job posting may be of interest to another individual. In another example, the sharing data used to calculate SRₚₒₛₜ is not restricted to a particular time period, but rather the data is weighted to give a higher value to recent sharing activity than to older sharing activity.

VRₚₒₛₜ can be calculated or determined using information available from the job posting system. For example, to calculate VRₚₒₛₜ, the job posting system can track each time an user clicks on a job posting in order to view further information about the job posting. In order to prohibit the employer from clicking on their own job posting, the job posting system can track only clicks on a job posting from individuals not associated with the employer. Additionally, as a user reviews numerous job postings, the user may click on a job posting multiple times in order to compare the job posting with another job posting. As such, when calculating VRₚₒₛₜ the system can restrict the viewing count to a single registered click per user per a predetermined time (e.g., per day or per week). The data about user clicks to view a job posting can be weighted to give a higher value to recent clicks and/or the data about user clicks can be limited to a predetermined, recent time period.

Aₑₘₚ can be calculated or determined using information available from the job posting system. For example, to calculate Aₑₘₚ, the job posting system can track the number of resumes that the employer has reviewed for a particular job posting. For example, the employer activity score can be increased when the employer reviews a large portion or percentage of the resumes submitted in response to the job posting. Tracking of employer activity related to a particular job posting can help to limit job postings from trending for which the position has already been filled.

CFₑₘₚ can be calculated or determined using information available from the job posting system. In one example, CFₑₘₚ is determined based on user ratings of various employers. In another example, CFₑₘₚ is determined by placing values on company information such as the company size, company benefits, the vacation policy, popularity of the employer, and other indicators of the companies culture. In some examples, the trending score for a job posting can be scaled based on the size of the employer or the size of the city in which the employer is located. For example, a and employer in Seattle, Wash. seeking to fill an IT position is likely to have higher scores for job posting views, sharing, applications, etc., as compared to an employer in Pensacola, Fla. seeking to fill a similar IT position due to the relative size of the job market in the two cities. Additionally, the trending score for a job posting can be scaled based on the size of the employer. For example, a small company having only 10 employees may not have the name recognition to promote a job as easily as a large, Fortune 100 company. In order to provide a variety of jobs and not only jobs from the largest of employers, the trending score for a job posting can be scaled accordingly. Thus, a scaling factor can be used in order to ensure that not only job postings from large employers in large cities are likely to become trending job postings.

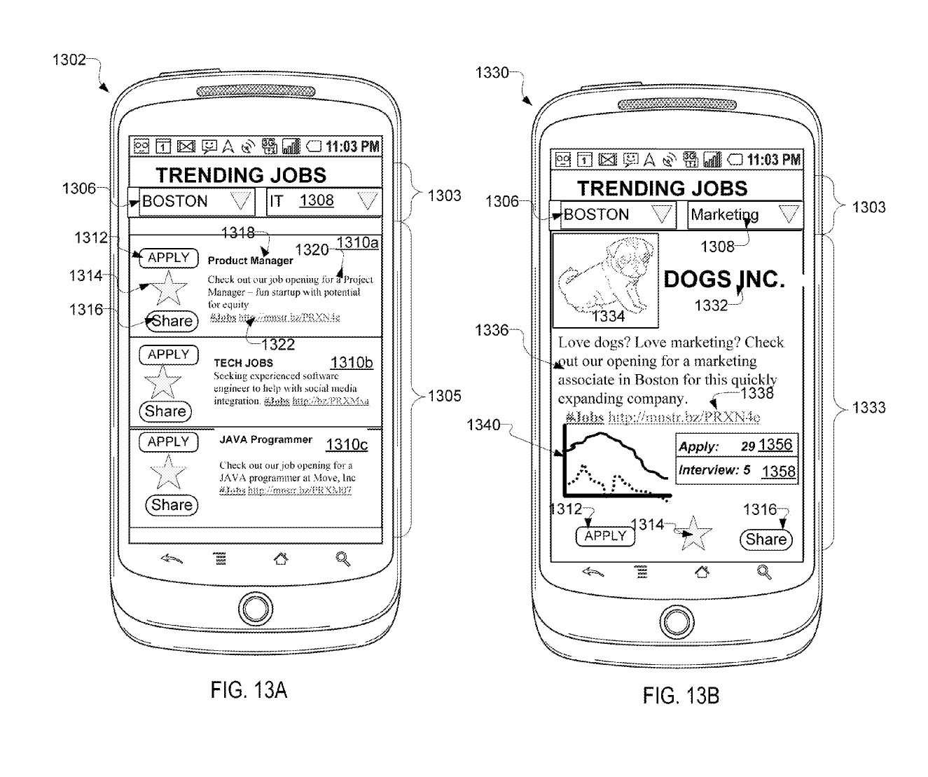

FIG. 13A shows an exemplary user interface 1302 for displaying trending job postings. The user interface provides a user with a single location to view job postings for which there is general excitement or interest amongst other users. User interface 1302 is divided into two sections, a filter section 1303 and a trending job posting section 1305.

The trending job posting section 1305 includes one or more posts 1310a-c that include the position name 1318 of the trending job posting, the job posting text 1320, and a link (e.g., link 1322) to the job posting. Thus, a user can quickly scan a set of popular job postings based on their response text and view jobs of interest by selection of the link 1322 to the job posting. Each of the posts 1310a-c in the trending job posting section 1305 includes selectable controls which enable the user to apply for the job posting (e.g., apply button 1312), favorite the job posting (e.g., favorite button 1314), or share the job posting with others via a post or e-mail (e.g., share button 1316). Selection of the apply button 1312 generates a post to the employer's data feed indicating the user's interest in speaking with the employer and applying for the job described in the job posting. For example, selection of the apply button 1312 can be the first step in forming a connection that is likely to lead to an interview for the user. Selection of the favorite button 1314 causes information about the job posting to be stored in a folder associated with the user so that the user can later review the subset of job postings which they selected. Use of the favorite button allows the user to quickly identify a subset of job postings which look interesting and then later view those job postings as a group. Selection of the share button 1316 causes an e-mail or posting to a social network to be generated from the employer. If an e-mail is generated, the user can select the recipients and the e-mail will include the original text of the job posting. If selection of the share button 1316 is enabled to generate a posting, a text statement suitable for posting to a social media platform (e.g., tweets via Twitter, Status via Facebook) can be generated which includes the text of the original post or a link to the text of the original post.

The filter section 1303 of user interface 1302 provides the user with a mechanism to filter trending job postings by job type (e.g., IT, marketing, legal, construction, etc.) and by location. To filter by location an user can select a particular location using drop down menu 1306 and to filter by job type the employer can select a particular job type using drop down menu 1308. While filtering can enable an user to view a subset of trending job postings in the location and/or job function, in some examples an user may desire to view an unfiltered list of job postings in order to see what the most popular currently available job postings are and then determine if they are interested enough to consider the location or job type.

In user interface 1302, multiple job postings, job postings are displayed on a single screen of a user device such as a mobile computing device, cellular telephone, etc. However, similar displays of trending candidates can be provided on a computer screen of a desktop or laptop computer. Additional trending job postings can be viewed by scrolling through a list of trending job postings.

FIG. 13B shows an exemplary user interface 1330 for displaying trending job postings. The user interface provides a user with easy viewing of job postings for which there is general excitement or entrance amongst other users. In contrast to user interface 1302, user interface 1330 displays a single trending job posting at a time. The user can click a button or swipe their finger across the screen to view subsequent trending job postings. Similar to user interface 1302, user interface 1330 is divided into two sections, a filter section 1303 and a job posting section 1333.

The trending job posting section 1333 includes information about a trending job posting, including the company name 1332, a picture of the company logo 1334, a short text statement about the position 1336, and a link to further information about the position 1338. Thus, a user can quickly scan a set of potential jobs based on brief information about the job and view further information about the job by selection of the link. User interface 1333 also includes selectable controls similar to those described above in relation to user interface 1302 which enable the user to apply for the job in the job posting (e.g., apply button 1312), favorite the job posting (e.g., favorite button 1314), or share the job posting with others via a post or e-mail (e.g., share button 1316).

User interface 1133 also includes a graphical indicia 1340 that provides information about how many times the job posting has been viewed and how many users have applied for the job in the job posting. For example, graphical indicia 1340 can conclude a graph of the number of applicants (e.g., as represented by the dotted line) and the number of users who have viewed the job posting (e.g., as represented by the solid line) over time. Thus, based on this information a user can determine how the popularity of the job posting has evolved over time and how competitive the market for the job is likely to be. Additionally, the user interface 1330 can include indicators of the total number of job applicants 1356 and the total number of interview requests from the employer 1358.

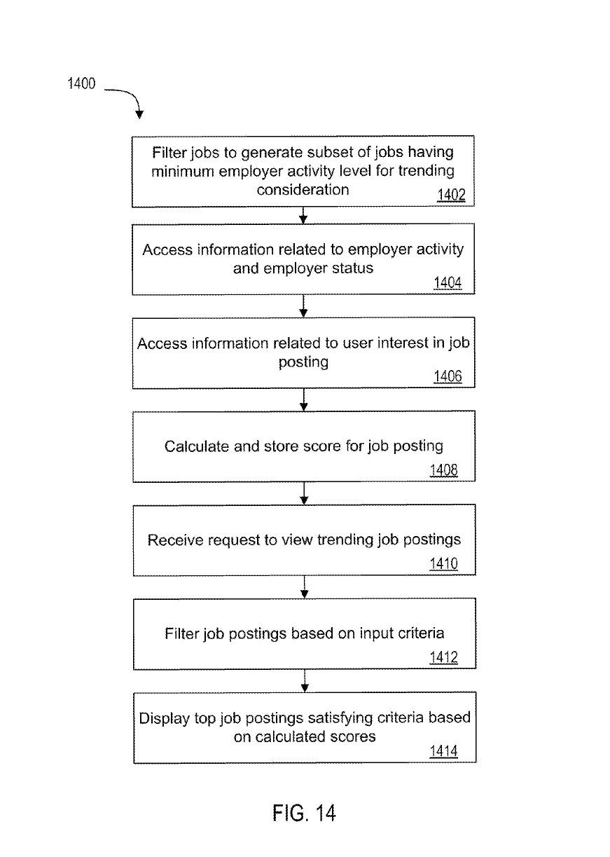

FIG. 14 shows a flowchart of a process 1400 for identifying and displaying trending job postings in the job posting system.

The job posting system filters users to generate a subset of job postings having a minimum activity level for trending consideration (1402). Filtering the job postings, based on employer activity level can ensure that job postings that have already been filled are less likely to become a trending job postings. For example, the job posting system can generate the subset of job postings by selecting only job postings with some employer activity at least once in the past week (or another predetermined time period).

In order to calculate the scores for each of the job postings in the determined subset of job postings having the minimum activity level, the system accesses information related to employer activity and employer status and information related to user interest in the job posting (1404, 1406). Exemplary information the job posting system can access can include information about the number of times a job posting has been viewed by different users, the number of times users have shared a job posting, and the number of times a user has applied to the job posting.

Using the accessed information, the job posting system calculates and stores scores for each of the job postings in the identified subset (1408). Such scores can be calculated, for example, as described above. The filtering of job postings (1402), accessing of information (1404, 1406), and calculating of scores for job postings (1410), can be performed on a regularly scheduled basis. For example, the job posting system can calculate new scores for users on a daily or hourly basis.

The job posting system receives a request to view trending job postings (1410). This request can include criteria by which the user desires to filter job postings. For example, the job posting system can enable a user to filter job postings based on industry type and location. The system filters job postings based on the user input criteria (1412). Using the filtered subset of job postings, the job posting system displays trending job postings satisfying the criteria based on the calculated scores (1414). For example, the job postings satisfying the filter criteria can be displayed in order that is based on the related scores. Alternatively, only a small subset (e.g., 10, 20, 30) of job postings having the highest copulated scores can be displayed to the user as trending job postings.

Network Environment

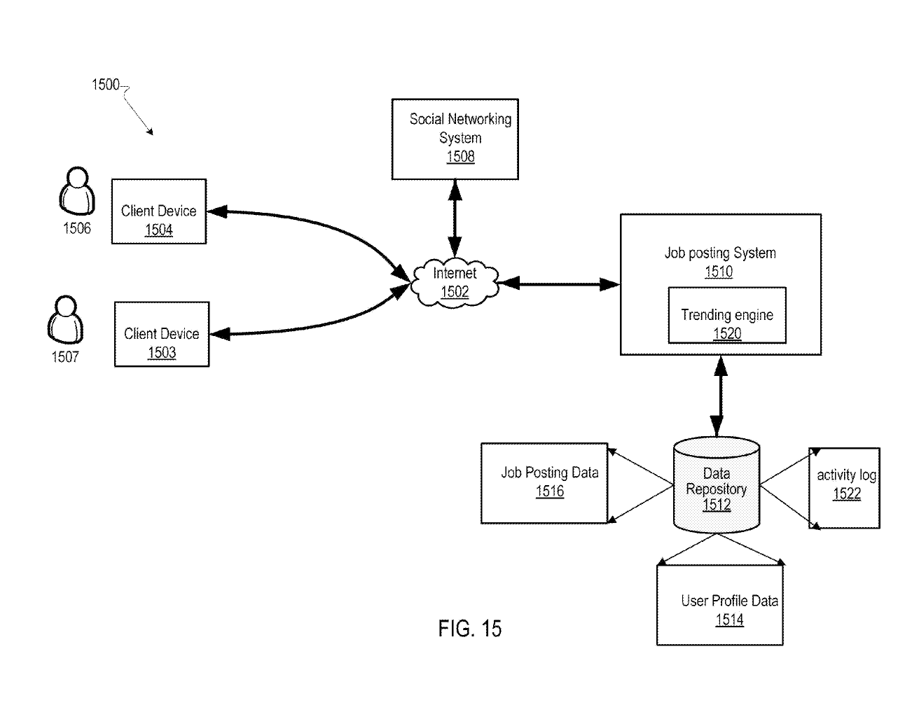

FIG. 15 is a block diagram of an example of a network environment 1500 enabling responses to a job posting to be provided to an employer's social media feed. Network environment 1500 includes network 1502, a client devices 1504 and 1503, job posting system 1510, and social networking system 1508. Network environment 1500 may include many thousands of data repositories, client devices, and social networking systems, which are not shown.

In an example, client device 1504 is associated with user 1506 and client device 1503 is associated with user 1507. In this example, user 1506 or 1507 may be a job seeker. Client devices 1504 and 1503 can be any computing device with access to the Internet such as a mobile telephone, a tablet computing device, a laptop computer, or a desktop computer.

In the example of FIG. 15, job posting system 1510 includes a system that hosts applications, including, e.g., an application for connecting employers and job seekers and an application 1520 for determining trending job postings and users. In an example, client devices 1504, 1503 may download a client application for interacting with job posting system 1510. In another example, client devices 1504, 1503 may use a web browser to access the job posting system 1510, e.g., rather than downloading a client application for interacting with the job posting system 1510. In an example, an application provided by the job posting system may be configured to render one or more of graphical user interfaces described herein. In an example, job posting system stores, in data repository 1512, information 1516 about job postings included in feeds from one or more social networking systems 1508, user profile data 1514 including a user's online resume and response text, and information 1522 about the activity within the job posting system such as job and resume views, connections, applications, sharing and favoriting.

In an example, users 1506, 1507 of job posting system access the job posting application by logging into the application from client devices 1504, 1503, respectively. Once logged in, users 1504, 1503 can view and respond to job postings provided in a job posting feed (e.g., as described herein). In this example, job posting system uses the social media account of the user to respond by posting a post in the social networking system of the employer from the account of the user. As such, users 1506, 1507 may have to be logged into the job posting system using a login of a social networking platform in order to review and respond to job postings in their job feed.

In the example of FIG. 15, social networking system 1508 is configured to implement social networking platform. Typically, a social networking platform includes an electronic resource (e.g., a web site) that enables users of the social networking platform to connect with other users and to receive updates from the other users in the form of electronic messages (e.g., posts). There are many different examples of social networking platforms. FACEBOOK, TWITTER, LINKEDIN, GOOGLE+, MYSPACE, and ORKUT are just a few examples. But, there are many others, and it is reasonable to expect many more to be launched in the future. The techniques described herein for handling data available within a social networking platform are widely applicable and may be applied to data available within any relevant social networking platform.

Social networking platforms frequently enable individual users (e.g., users who have registered with a platform and/or who have been assigned a unique or otherwise identifying identifier by the platform) to establish connections with other user identities. These connections between users may reflect relationships between the underlying human users who correspond to the user identities. For example, a connection between two users within a social networking platform may reflect a social friendship (e.g., developed through physical interaction in the real-world and/or through on-line interaction in the cyber-world) or a professional relationship between the underlying human users who correspond to the user identities. In some social networking platforms, a user may be able to unilaterally form a connection with another user. For example, a social networking platform may enable a first user to form a connection to a second user simply by specifying a desire to form a connection to the second user and without requiring approval of the connection by the second user. Alternatively, in other social networking platforms, the formation of connections between two users may be a bilateral process. For example, in such social networking platforms, when a first user specifies a desire to form a connection to a second user, the social networking platform may establish the connection only after the second user approves the formation of the connection between the first user and the second user.

In an example, job posting system 1510 is configured to retrieve, from social networking system 1508, a feed that includes job postings submitted by employers on the social networking system.

Job posting system 1510 can be a variety of computing devices capable of receiving data and running one or more services, which can be accessed by one or more of client devices 1504, 1503. In an example, job posting system 1510 can include a server, a distributed computing system, a desktop computer, a laptop, a cell phone, a rack-mounted server, and the like. Job posting system 1510 can be a single server or a group of servers that are at a same position or at different positions. Job posting system 1510 and each of client devices 1504, 1503, and social networking system 1508 can run programs having a client-server relationship to each other. Although distinct modules are shown in the figures, in some examples, client and server programs can run on the same device.

Job posting system 1510 can receive data from each of client devices 1504, 1503 and social networking system 1512 through an input/output (I/O) interface. I/O interface can be a type of interface capable of receiving data over a network, including, e.g., an Ethernet interface, a wireless networking interface, a fiber-optic networking interface, a modem, and so forth. Job posting system 1510 also includes a processing device and memory. A bus system, including, for example, a data bus and a motherboard, can be used to establish and to control data communication between the components of the job posting system 1510.

A processing device of the Job posting system 1510 can include one or more microprocessors. Generally, the processing device can include an appropriate processor and/or logic that is capable of receiving and storing data, and of communicating over a network (not shown). The memory can include a hard drive and a random access memory storage device, including, e.g., a dynamic random access memory, or other types of non-transitory machine-readable storage devices. The memory associated with job posting system 1510 stores computer programs that are executable by a processing device. These computer programs may include a data engine (not shown) for implementing the operations and/or the techniques described herein. The data engine can be implemented in software running on a computer device (e.g., application system 1522), hardware or a combination of software and hardware.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible program carrier for execution by, or to control the operation of, a processing device. Alternatively or in addition, the program instructions can be encoded on a propagated signal that is an artificially generated signal, e.g., a machine-generated electrical, optical, or electromagnetic signal that is generated to encode data for transmission to suitable receiver apparatus for execution by a processing device. The machine-readable medium can be a machine-readable storage device, a machine-readable storage substrate, a random or serial access memory device, or a combination of one or more of them.

The term “processing device” encompasses all kinds of apparatus, devices, and machines for processing data, including by way of example a programmable processor, a computer, or multiple processors or computers. The processing device can include special purpose logic circuitry, e.g., an FPGA (field programmable gate array) or an ASIC (application-specific integrated circuit). The processing device can also include, in addition to hardware, code that creates an execution environment for the computer program in question, e.g., code that constitutes processor firmware, a protocol stack, a database management system, an operating system, or a combination of one or more of them.

A computer program (which may also be referred to as a program, software, a software application, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer may be a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer implemented method comprising:
identifying, by a computer system, a plurality of trending job posts from job posts maintained in a social networking platform based at least in part on a number of individuals who have responded to the job post;
associating a user-selectable control with the trending job posts;
sending data to a user device to cause the user device to display at least some of the trending job posts and the associated selectable controls;
receiving, at the computer system from the user device, an indication of interest in a particular one of the trending job posts based on selection of the selectable control associated with the particular one of the trending job posts by the user device; and
generating, by the computer system, a post in the social networking platform of an employer associated with the particular trending job post for which the indication of interest was received, the post including response text and a link to a resume of a user associated with the user device.

2. The method of claim 1, wherein identifying the plurality of trending job posts comprises identifying the trending job posts based on a score calculated based on a first component indicative of user interest related to a job posting and a second component indicative of employer activity associated with the job posting.

3. The method of claim 1, wherein identifying the plurality of trending job posts comprises:
for a plurality of job postings, calculating a trending score based at least in part on a number of times the job posting has been viewed and a number of users who have responded to the job posting; and
selecting from the job postings the trending job posts based on the calculated trending scores.

4. The method of claim 1, wherein identifying the plurality of trending job posts comprises identifying trending posts based on a score calculated according to score=Σ(a*ARₚₒₛₜ+b*SRₚₒₛₜ+c*VRₚₒₛₜ+d*Aₑₘₚ+e*CFₑₘₚ) where a, b, c, d, and e are weighting factors, ARₚₒₛₜ is a measure of how many users have applied for the job posting, SRₚₒₛₜ is a measure of how many users have shared the job posting with other users, VRₚₒₛₜ is a measure of how many users have viewed the job posting, Aₑₘₚ is a measure of the employer's activity level in the job posting system, and CFₑₘₚ is a measure related to the company.

5. The method of claim 1, wherein identifying the plurality of trending job posts comprises identifying trending posts based on a score calculated based at least in part on a measure of how many users have applied for the job posting, a measure of how many users have shared the job posting, a measure of how many users have viewed the job posting, and a measure of the employer's activity.

6. The method of claim 1, further comprising sending data to a user device to cause the user device to display a visual indicia of viewing and application rate information for the trending job posts.

7. The method of claim 1, further comprising:
prior to identifying the plurality of trending job posts, filtering a set of job posts to remove job posts having an activity level below a threshold.

8. The method of claim 1, further comprising:
receiving from the employer at the computer system a request to view a resume of a user associated with the post in the social networking platform of the employer; and
enabling access to the employer to view the resume of the user.

9. A computer implemented method comprising:
identifying, by a job posting system, a plurality of trending users from a plurality of users of the job posting system based at least in part on a number of employers who have viewed the user's resume;
associating a selectable control with the trending users;
sending data to an employer device to cause the employer device to display at least some of the trending users and the associated selectable controls;
receiving, at the job posting system from the employer device, a request to view a resume of a trending user based on selection of the selectable control associated with a particular one of the trending users; and
enabling access to the employer to view the resume of the trending user.

10. The method of claim 9, wherein identifying the plurality of trending users comprises identifying a trending users based on a score calculated based on a first component indicative of employer interest related to particular user and a second component indicative of user activity.

11. The method of claim 9, wherein identifying the plurality of trending users comprises:
for a plurality of users, calculating a trending score based at least in part on a number of times the user's resume has been viewed; and
selecting the trending users based on the calculated trending scores.

12. The method of claim 9, wherein identifying the plurality of trending users comprises identifying trending users based on a score calculated according to score=Σ(a*CRₑₘₚ+b*SRₑₘₚ+c*IRₑₘₚ+d*Lᵤₛₑᵣ+e*SRᵤₛₑᵣ+f*ACᵤₛₑᵣ) where a, b, c, d, e, and f are weighting factors, CRₑₘₚ is a measure of how frequently the user's resume is viewed by an employer, SRₑₘₚ is a measure of how frequently an employer shares a user's resume, IRₑₘₚ is a measure of how often employer initiates an interview with the user, Lᵤₛₑᵣ is a measure of how frequently the user logs into the job posting system, SRᵤₛₑᵣ is a measure of how frequently the user shares job postings with other users, and ACᵤₛₑᵣ is a measure of how many times the user has applied for a job using the job posting system.

13. The method of claim 9, wherein identifying the plurality of trending users comprises identifying trending users based on a score calculated based at least in part on resume viewing information; interview request information; resume sharing information; and user activity information.

14. The method of claim 9, further comprising sending data to the employer device to cause the employer device to display a visual indicator of factors influencing identification of the user as a trending user.

15. The method of claim 9, further comprising:
prior to identifying the plurality of trending users, filtering a set of users to remove users having an activity level below a threshold.

16. A computer program product tangibly embodied on a computer readable medium, the computer program product comprising instructions to cause a processor to:
identify a plurality of trending job posts from job posts maintained in a social networking platform based at least in part on a number of individuals who have responded to the job post;
associate a user-selectable control with the trending job posts;
send data to a user device to cause the user device to display at least some of the trending job posts and the associated selectable controls;
receive an indication of interest in a particular one of the trending job posts based on selection of the selectable control associated with the particular one of the trending job posts by the user device; and
generate a post in the social networking platform of an employer associated with the particular trending job post for which the indication of interest was received, the post including response text and a link to a resume of a user associated with the user device.

17. A computer program product tangibly embodied on a computer readable medium, the computer program product comprising instructions to cause a processor to:
identify a plurality of trending users from a plurality of users of the job posting system based at least in part on a number of employers who have viewed the user's resume;
associate a selectable control with the trending users;
send data to an employer device to cause the employer device to display at least some of the trending users and the associated selectable controls;
receive a request to view a resume of a trending user based on selection of the selectable control associated with a particular one of the trending users; and
enable access to the employer to view the resume of the trending user.
